(19) United States
(12) Patent Application Publication
(10) Pub. No.: US 2012/0004961 A1
(43) Pub. Date: Jan. 5, 2012

(54) System and Method for Delivering Advertising Information to Transportation Users

(76) Inventor: Lori Flynn, Racine, WI (US)

(21) Appl. No.: 12/829,614

(22) Filed: Jul. 2, 2010

(51) Int. Cl. G06Q 30/00

(52) U.S. Cl. 705/14.5; 705/14.49

(57) ABSTRACT

A computer-implemented system for providing targeted advertising information based on the content of provided transportation information. The system includes a transportation information system configured to receive a request for transportation information based on one or more user provided vehicle selection criteria and generate transportation information including location tracking information for a vehicle selected based on the vehicle selection criteria. The system further includes an advertising selection system configured to select one or more targeted advertisements based on at least the location tracking information for the selected vehicle and an advertising system configured to transmit a transportation message including the transportation information and the targeted advertisement.

### BACKGROUND

The present invention relates generally to the field of providing targeted advertising information. More particularly, the present invention relates to a system and method for providing targeted advertising information based on provided public transportation information.

Public transportation may include any passenger transportation service which is available for use by the general public or a subset of the general public. Examples may include shared-ride services, such as buses, vans, trolleys, streetcars, subways, etc. Often, a user is presented with a selection of public transportation options from which to choose.

Public transportation provides numerous advantages over personal transportation by reducing expenses, pollution, overcrowding on roads, the number of accidents, etc. However, one common complaint about public transportation is the reduction in convenience for the user. For example, users often have to wait for the public transportation in a potentially unfamiliar location.

To increase the convenience to the user, public transportation systems have developed systems and methods for providing users with information about their transportation that can be specifically customized to each individual including when it will arrive at their stop, when it will arrive at their destination, etc. Providing this information to users significantly improves the experience of using public transportation.

However, transportation vehicles actual schedules often deviate significantly from their defined schedules, particularly during off-peak travel times when periods between vehicles is longer. Users are often provided with this information while they are already waiting at the public transportation stop or while they are in an unfamiliar location. If users know the amount of time that they would have to wait and the options available to them based on that time, this time spent waiting could be more optimally spent of other activities, such as working, completing errands, shopping, relaxing, etc.

What is needed is a system and method for providing information to users of public transportation based on received transportation information. What is further needed is such information customized to the user based on their current location, their location of departure, a user profile, the content of the user information such as expected departure time, trip time, expected destination time, etc.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

One embodiment of the invention relates to a computer-implemented system for providing targeted advertising information based on the content of provided transportation information. The system includes a transportation information system configured to receive a request for transportation information based on one or more user provided vehicle selection criteria and generate transportation information including location tracking information for a vehicle selected based on the vehicle selection criteria. The system further includes an advertising selection system configured to select one or more targeted advertisements based on at least the location tracking information for the selected vehicle and an advertising system configured to transmit a transportation message including the transportation information and the targeted advertisement.

Another embodiment of the invention may be configured such that the tracking information includes timing information indicating a time until one or more transit events and the targeted advertisement is selected based on at least the location and the timing information. The advertising system may be configured to periodically provide updated transportation information and wherein the targeted advertisement changes based on changes to the timing information.

Another embodiment of the invention may be configured such that the transportation information includes timing information indicating when the selected vehicle will arrive at a given location and the targeted advertisement is selected based on the timing information. The tracking information may include timing information and the targeted advertisement is selected based on the timing information and predicted weather conditions for the timing information.

Yet another embodiment of the invention may be configured such that the tracking information includes timing information and the targeted advertisement is selected based on the timing information and one or more user parameters. The user parameters may include a history of user transportation activities and the targeted advertisement is selected based on a detected deviation from the user transportation activities.

Alternative examples and other exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a transportation based advertising system configured to provide targeted advertising information based on the content of provided transportation information, according to an exemplary embodiment;

FIG. 2 is the advertising selection system of FIG. 1 in further detail, according to an exemplary embodiment;

FIG. 3 is a flowchart illustrating a method for transmitting a request and receiving transportation information including advertising information, according to an exemplary embodiment; and

FIG. 4 is a flowchart illustrating a method for providing transportation information including advertising information based on a received request, according to an exemplary embodiment.

### DETAILED DESCRIPTION OF THE PREFERRED EMBODIMENTS

Before describing in detail the particular improved system and method, it should be observed that the invention includes, but is not limited to, a novel structural combination of conventional data/signal processing components and communications hardware and software, and not in particular detailed configurations thereof Accordingly, the structure, methods, functions, control, and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

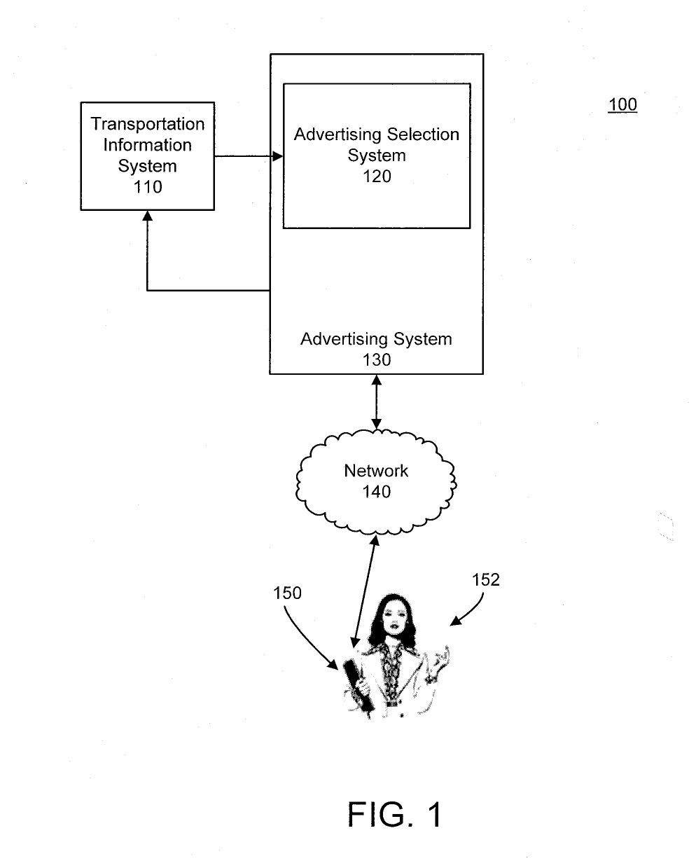

Referring to FIG. 1, a transportation based advertising system 100 configured to provide targeted advertising information based on the content of provided transportation information is shown, according to an exemplary embodiment. System 100 includes transportation information system 110, an advertising selection system 120, and an advertising system 130 configured to provide targeted advertising information based on the content of provided transportation information to a personal computing device 150 associated with a user 152 over a communication network 140. Although shown according to a specific embodiment, system 100 may alternatively be configured to include more, fewer, and/or different components configured to implement functions described herein.

Transportation information system 110 may be any computer-implemented system configured to provide real-time transportation information. Transportation information may be any type of information related to a transportation vehicle. Transportation information may include a time until the occurrence of one or more transit events, such as vehicle arrival, vehicle departure, vehicle boarding, etc. System 110 will generally be used in tracking and providing information related to mass transportation vehicles including, but not limited to, buses, trains, subways, streetcars, trolleys, shuttles, vanpools, taxis, rental cars, etc. that are tracked in some fashion. Transportation system 110 may be configured to provide information related to any vehicle, combination of vehicles, combination of types of vehicle, etc. based on the information being requested by the user 152.

System 110 is configured to receive tracking information about the vehicle using any of a variety of tracking methods and systems. Exemplary tracking methods may be real-time tracking methods including, but not limited to, global positioning satellite (GPS) tracking, voice or data communication tracking, for example via cell phone voice communication, activation of a sensor at a given landmark, etc. Tracking may also be configured to use other tracking methods such as schedule based tracking, scheduled interval times, etc. where the tracking schedule is modified based on one or more factors such as standard deviation based on a schedule deviation history archive, time of day, traffic reports, weather reports, accident and/or disaster reports, etc. Tracking predictions may also be modified based on manually provided reports such a delay reports, re-routing reports, trip cancellation reports, accidents, evacuations, etc. Tracking may also be performed using any combination of the above tracking methods.

Transportation information may include any information related to transportation vehicle tracking. The information may be related to a single vehicle or multiple vehicles, based on the request made by user 152. System 130 may be configured to provide vehicle identification information to transportation information system 110 to identify the vehicle or vehicles. Exemplary information includes expected arrival time, expected departure time, wait time before next vehicle, and/or any other time associated with the vehicle at one or more locations, updates to timing information, a complete schedule based on a user-provided itinerary, etc.

Transportation information system 110 may be configured to receive a vehicle selection criteria input from a user 152. The vehicle selection criteria may include a user location, which may be used to determine the nearest transportation stop and the next vehicle to arrive at that stop, a start location, an end location, a preferred transportation vehicle, etc.

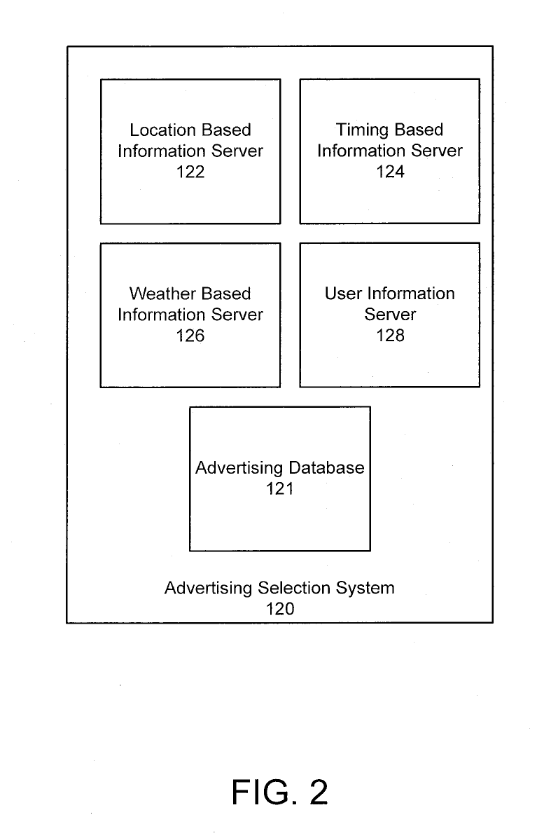

Advertising selection system 120 may be a computer-implemented system for generating targeted advertising information based on the tracking information contained in the transportation information received from system 110. The targeted advertising information may further be generated based on one or more additional information inputs such as a user location, a time of day, a day of year, current weather conditions, a predicted time-to-wait, user specific information, etc. as will be discussed below in further detail with reference to FIG. 2.

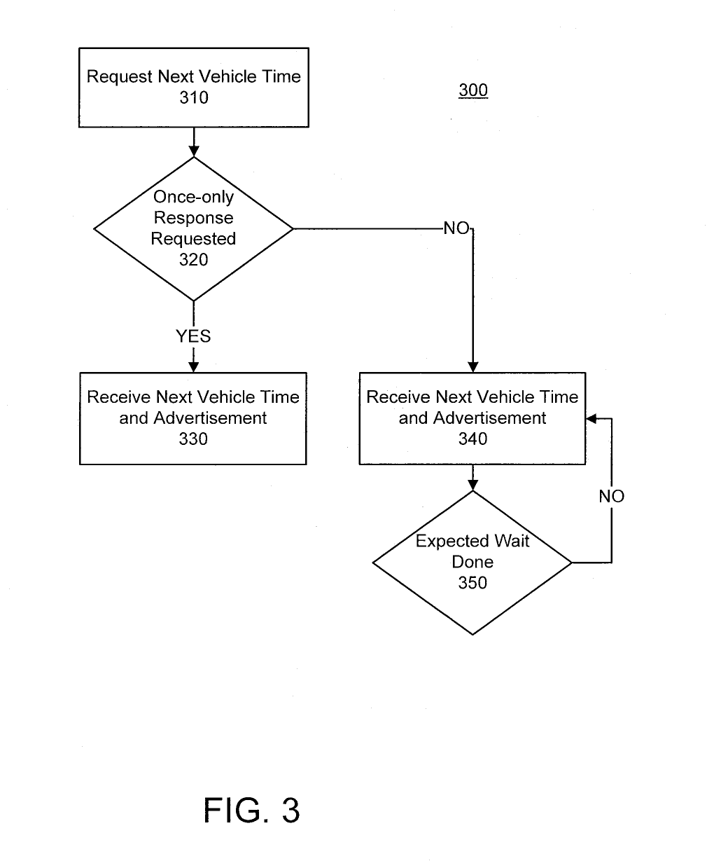

Advertising system 130 may be a computer-implemented system including the advertising selection system 120 for providing the transportation information from system 110 in combination with the generated advertising information of system 120 to personal computing device 150 over communication network 140. System 130 may be configured to provide the information based on a received request from a user as described in further detail below with reference to FIG. 3.

Communication network 140 may be any communication network configured to allow information to be transmitted between system 130 and personal computing device 150. According to an exemplary embodiment, device 150 may be a cellular or other wireless computing device such as a smart phone using SMS style messaging and communication network 140 may be a cellular network. In another exemplary embodiment, personal computing device 150 may be a computer and network 140 may be the Internet.

Personal computing device 150 may be any type of computing device configured to send and receive information. Device 150 may further be a plurality of computing devices such that system 130 may transmit messages simultaneously to a user's smart phone, laptop, pager, work computer, home computer, etc. For example, device 150 may be a smart phone configured to use one or more of a web browser, a text messaging program, an embedded GPS device, voice messaging services, etc. to send and receive messages with system 130.

Referring to FIG. 2, the advertising selection system 120 of FIG. 1 is shown in further detail, according to an exemplary embodiment. Advertising system 120 may be implemented using a computer system coupled to a plurality of databases containing archived and actively updated information and associated advertising information servers. The plurality of databases and servers may be configured to provide advertising information correlated to the transportation information received from system 110. Exemplary servers may include a location based information server 122, a timing based information server 124, a weather based information server 126, a user information server 128, etc.

System 120 may further include an advertising information database 121 including stored advertising information database. Stored advertising information may include video files, audio file, picture files, text files, etc. configured for combination with the transportation information from system 110. The advertisements may be as simple as a text message section where one part of the text message would give the user the next expected vehicle arrival and/or departure time and the other part of the text message would give a short text advertisement. For example, “Hot good coffee at Jane's Cafe, at 12th Street and 4th Avenue.”

The advertising information may use images that are part of software used for the transit vehicle next-time request application and stored on computing device 150. For example, a coffee shop advertisement may use a locally stored image on the user's personal computing device 150. The personal computing device 150 may be the device the user is utilizing to find out the time to expect the next vehicle, or time to expect any of a set of appropriate vehicles, to satisfy the user's request. Stored images may be used in combination with newly downloaded text and possibly newly downloaded images and/or video.

Advertisements may be text, audio, video, etc. or a mixture of formats. The particular mixture (or singular) of types of advertising information may be dependent on the personal computing device 150 as identified by automated or manual means. For example: A user may select the type of machine they are using, or in another embodiment, the application may determine or approximately determine the user's transaction bandwidth or CPU speed.

According to an exemplary embodiment, the advertising information may be provided with the transportation information, in a separate message sent before or after the transportation message. For example, a user may be required to click-through the advertisement to view the transportation information, advertising information may be provided with alternating requests, etc.

Location based information server 122 may be configured to include a database containing advertising information related to one or more particular locations. The particular location may be any location based identification such as a mass transit stop, a city street, a zip code, etc. Server 122 may be configured to store and allow retrieval of location based advertisements. Location based advertisements can correlate to, for example, start and/or end transportation destinations for the user 152. For example, where one location is Wall Street, high-priced vacation trip or conservative business clothing advertisements may be stored in a database associated with that particular location, or a field in a database record may be provided indicating the association. According to another example, where the start or end location is close to a particular store that has paid for advertisements, advertisements for that particular store would be stored in a database record associated with that location to increase the likelihood of their selection by server 122.

Timing based information server 124 may be configured to include a database containing advertising information related to particular timing constraints. Wait time before the transit vehicle arrival may influence advertisements to be provided by server 124. For example, a five minute wait may increase the probability that advertising information for coffee shops and convenience stores nearby will be provided, and potentially increase the probability of general non-location-specific advertisements will be served. Alternatively, if there is a longer wait, such as 30 minutes or more, advertising information such as for nearby restaurants, bars, clubs, and clothing stores may be more likely to be provided.

Location information may include a wide variety of information related to any desired location. For example, the wait and location information may be combined in order to place appropriate advertisements. For example, if there is a long wait in a high crime area as indicated by the information stored by server 122, advertisements for someplace nearby and safe may be served.

Server 124 may be configured to intelligently utilize timing information in accordance with user customizable rules. The time of day may affect the advertisements served. For example, advertisements for stores currently open, or advertisements for stores open for some period of the wait time, may be more likely to be served. Serving an advertisement can included presenting an advertisement in text, audio, video, and/or any other method of presentation. Alternatively, the current time of day may be ignored, so that advertising information for known location(s) of the user's transit would be more likely to be served. In this case, advertising information might still be served even if the particular business in the advertisement is currently closed. This may be useful for an advertiser since the user is known to go to that particular location, even if, at the current time, the business is closed. The time of day in conjunction with a user defined or provided travel mode, or in conjunction with a destination, may be used to serve appropriate advertisements. For example, this conjunction of information may be used to identify likely late commuters or returning theater-goers or bar-hoppers, and thus serve appropriate advertisements for business classes, theater shows, dance clubs, etc.

Weather based information server 126 may be configured to include a database containing advertising information related to weather information. The weather information may be current weather, predicted weather at the predicted arrival time of the transportation vehicle, predicted weather at a predicted arrival time of the user at their destination, etc. Weather may influence advertisements (in conjunction with knowledge that the application user often starts without a vehicle and thus is likely to be affected by the outdoor environment). For example, if it is raining, advertising information for stores with umbrellas and raincoats, and brands of raincoats, would be more likely to be provided. According to another example, if it is sunny and hot, advertising information for stores selling and brands of sunscreen, hats, and even fans would be more likely to be provided. Since the user is likely to be directly affected by the weather and thus likely to be feeling hot, the customer might be more easily influenced by advertising information to purchase a fan. Alternatively, if it is snowing, advertisements for stores selling and brands of boots, sweaters, jackets, and vacations in warm places may be more likely.

User information server 128 may be configured to include a database containing advertising information related to the specific user 152. One possible implementation may include a web-browser type ‘cookie’, or login information, user ID, cell phone number, pager number, or identifier from the requesting machine or requesting software, that is associated with previous and/or current transit requests. These methods may be used to gather a set of information about a transit user, or about a set of transit users from one machine. That information set may be used to serve appropriate advertisements to a user. For instance, a pattern of user requests on Mondays through Fridays, at 6:30 AM and 3:30 PM, would likely indicate a work commute. Advertising information specific to pre-work and post-work may be more likely at these times for this type of user. For example: If the user requests a different location at these times, the user would be more likely on vacation or else sick. Server 128 may be configured to receive, analyze, and store user information such that advertisements appropriate for those situations may be more likely to be served. According to another example, where the assumed ‘work destination’ was Wall Street, the financial district in New York City, different advertisements would be more likely to be served than if the daily destination was an industrial Brooklyn neighborhood. According to yet another example, where the assumed ‘home destination’ is a known expensive real estate area, the advertisement server may be more likely to serve advertising information for expensive goods and services. According to yet another example, where the user is running later than usual according to a stored pattern of behavior, advertisements for time-savers, coffee, and other appropriate goods and services may be more likely to be provided. The advertisement server may be more likely to serve all known locations the user frequents, even if those locations are not part of the current trip.

It is important to recognize that multiple servers and databases of system 120 may be configured to operate cooperatively to provide optimized advertising information. For example, advertisers located at a start location or the end location based on information from server 122 may be favored depending on the length of the wait time at the start and/or time of day based on information from server 124.

System 120 may further use external information to determine the type of advertising information to provide. For example, the type of vehicle the user requests or described in the information from system 110 may be used to serve appropriate advertisements. For example a subway rider might be statistically more likely to work and live is specific areas of a metropolitan area or have defined interests, and advertisements targeted to those metropolitan areas or those defined interests would be more likely to be provided for users identified as subway riders.

Referring now to FIG. 3, a flowchart 300 illustrating a method for transmitting a request and receiving transportation information including advertising information is shown, according to an exemplary embodiment. The method of flowchart 300 may be implemented by a user 152 using a personal computing device 150.

In a step 310, a user may send a request for transportation information to system 130. The request may be for any of a variety of different types of transportation information, frequency of updates, etc. For example, FIG. 3 shows a request for vehicle next arrival at a location. The request may be made for a single response giving the next arrival time, or for multiple responses, or for a time or times in conjunction with updates if the next expected arrival time changes as determined by system 130 in a step 320.

According to an exemplary embodiment, the user may request some set of requests, or some number of requests that can be made in the future. The request may be made via selecting from options given by application software implemented by personal computing device 150. The request may include a unique name for a vehicle desired and a unique identifier for start location. The request may include a start time or times, or alternatively transit vehicle arrivals closest after the current time may be assumed in the request. The request may be via selecting spots (start/end) on a map. The request may include a direction of travel, e.g., uptown A train versus downtown A train.

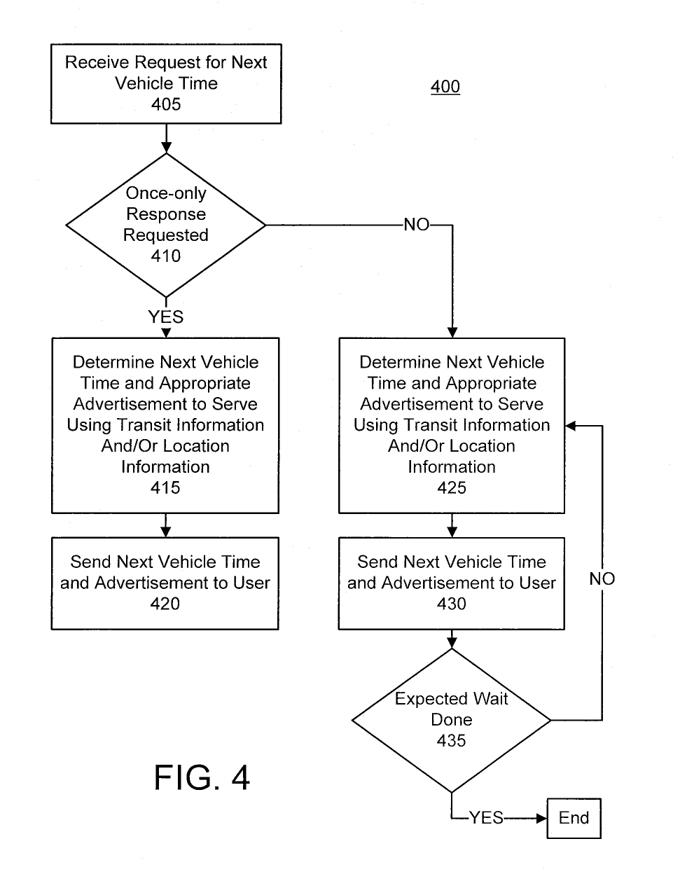

The request may include information singularly identifying a particular transit vehicle as well as a start time or approximate start time after which next expected arrival time is requested and the transportation information will be provided in a step 330. The transportation information is configured to include selected advertising information as described in FIG. 2, above, and FIG. 4, below.

Alternatively, the request may be a one-time user request for daily (or some subset of days of the week, days of the month, or days of the year) next-expected vehicle (or set of vehicles) at or near a particular location and before, after, or approximately at a particular time. Initial transportation information configured to include selected advertising information is provided in a step 340. After system 130 determines that an expected wait time has elapsed in a step 350, step 340 may be repeated, transmitting updated transportation information and potentially advertising information based on the changed tracking information indicated by the transportation information. According to one exemplary embodiment, user 152 may make the request, but only get an update if one or more vehicles were running off-schedule. This ‘off-schedule’ parameter might be set by the user. For example, the user might choose to be updated only if the vehicle were running more than 3 minutes late, or if running any number of minutes early, or alternatively even if only 1 minute late.

When requesting a ‘next-vehicle time for a location’, user 152 may indicate multiple locations/times. For example, the user may indicate that the user would like a vehicle from a first location to a second location now (or within some time of now), or else a vehicle from the first location to a third location later. Advantageously allowing the user to request multiple sets of transportation information allows the advertising information to be customized to their potential needs. For example, where a next train is not arriving soon, user 152 may decide to have dinner with friends and need a ride home in 2 hours instead of now. The user may also request transportation information to determine the best-vehicle time for a location, where start/end locations are given, and multiple transit types possible with different associated advertising information.

In a step 330, advertising information may be provided to user 152 through device 150 correlated to transit information provided and/or to related information known as described herein. The advertisement may be selected by advertising selection system 120 based on any of a variety of methods. For example, the advertisements may be selected based on the time since they were last displayed. This method may be altered by displaying some advertisements more often based on upgraded pricing paid by the advertisers, based on the particular users targeted by the advertisement, based on the proximity to a specific location, the current weather, the time of day, etc. The methods may be implemented using any of a variety of correlation factors, such as user types, time frames, weather conditions, start locations, crime rates of locations, accidents affecting transit, approximate locations of users, types of transit vehicles, user profile data, etc. Instead, or in addition, the correlation factors can be chosen from by advertisers to determine their preference for when their advertisement should be served (in addition to the number of ads served, average, standard deviation, etc.). Advertisers could weigh the importance of multiple profile factors, could choose to only focus on specific customer profiles, or to focus a specific percentage of ads to specific factors and another percentage of ads to other factors, etc.

Advertising information may be provided by advertisers desiring to provide advertising information to transportation users. An advertiser may be provided with a number of different targeting options, such as number of advertisements served in a given time frame, an average and/or standard deviation of the number of time the advertisement will be served over a time frame, number of advertisements served per set of requests, a probability or guarantee of the number of times the advertisement is provided within any time frame. Advertisements may select advertising option to maximize their effect based on a desired pricing level. Pricing may be set based on any number of defined criteria, including but not limited to number of ads served, average number of ads served per time frame, amount of standard deviation allowed if average number of ads is specified per time period, bandwidth required per specific ad (for example, video advertisements versus text advertisements), proximity to ‘ideal customer’ specifics for ad served (i.e., if ‘ideal customer’ is located in one of 3 locations, travels at a specific time of day, during specific weather, and via a subway, then if 75% of these specifics true for a particular ad served, 75% of the ‘ideal customer’ rate would be paid by the advertiser), user types, time frames, weather conditions, start locations, crime rates of locations, accidents affecting transit, approximate locations of users, types of transit vehicles, user profile data, etc.

Referring now to FIG. 4, a flowchart 400 illustrating a method for providing transportation information including advertising information based on a received request is shown, according to an exemplary embodiment. The method of flowchart 400 may be implemented by system 130 in combination with system 110 and 120.

In a step 405, the request generated by a user 152 described above with reference to FIG. 3 is received over network 140 by advertising system 130. A determination is made in a step 410 whether the request is a one time request or a request for continuously updated transportation information.

If the request is a one time request, system 130 may request transportation information from system 110 in a step 415. In step 415, advertising selection system 120 is configured to determine advertising information to be provided based at least on the tracking information contained in the transportation information received from system 110 using the servers and associated databases described above with reference to FIG. 2. This advertising and transportation information may be delivered to the user 152 at device 150 in a transportation information message in a step 420.

Alternatively, where system 130 determines that the message is a request for continuously updated information in step 410, a transmitted transportation information message may be generated and sent by system 130 in steps 425 and 430, respectively, similar to step 415 and 425, described above. System 130 may then be configured to monitor elapsed time relative to an update parameter dictating the frequency of updates in a step 435. If the update time has elapsed an updated transportation message may be sent in step 425. The updated transportation information may include updated advertising information based on, for example, the change in wait time, change in user location, an advertising information rotation schedule, etc. If the current time matches the expected arrival time of the transportation vehicle, system 130 completes the process in a step 440.

Advantageously, system 100 may be used to provide targeted advertising to transit users in conjunction with real-time and/or scheduled vehicle location data. The targeted advertising may be selected based on the vehicle location data. The location data may further be selected based on additional factors such as location, time of data, day of the year, current and/or predicted weather, time to wait, etc. System 100 reduces or eliminates user cost to provide the real time next expected vehicle information supplemented by well targeted advertising. The advertising would allow users to receive the information while performing other activities, such as those indicated in the advertising information.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the transportation information tracking methods, information type, advertising targeting inputs, etc. that are used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A computer-implemented system for providing targeted advertising information based on the content of provided transportation information, comprising:
a transportation information system configured to receive a request for transportation information based on one or more user provided vehicle selection criteria and generate transportation information including location tracking information for a vehicle selected based on the vehicle selection criteria;
an advertising selection system configured to select one or more targeted advertisements based on at least the location tracking information for the selected vehicle; and
an advertising system configured to transmit a transportation message including the transportation information and the targeted advertisement.

2. The system of claim 1, wherein the transportation information includes timing information indicating a time until one or more transit events, the targeted advertisement is selected based on at least the location and the timing information.

3. The system of claim 2, wherein the advertising system is configured to periodically provide updated transportation information and wherein the targeted advertisement changes based on changes to the timing information.

4. The system of claim 1, wherein the transportation information includes timing information indicating a time until one or more transit events and the targeted advertisement is selected based on the timing information.

5. The system of claim 1, wherein the tracking information includes timing information and the targeted advertisement is selected based on the timing information and predicted weather conditions for the timing information.

6. The system of claim 1, wherein the tracking information includes timing information and the targeted advertisement is selected based on the timing information and one or more user parameters.

7. The system of claim 6, the user parameters include a history of user transportation activities and the targeted advertisement is selected based on a detected deviation from the user transportation activities.

8. A computer-implemented method for providing targeted advertising information based on the content of provided transportation information, comprising:
receiving a request for transportation information based on one or more user provided vehicle selection criteria;
generating transportation information including location tracking information for a vehicle selected based on the vehicle selection criteria;
selecting one or more targeted advertisements based on at least the location tracking information for the selected vehicle; and
transmitting a transportation message including the transportation information and the targeted advertisement.

9. The method of claim 8, wherein the transportation information includes timing information indicating a time until one or more transit events and the targeted advertisement is selected based on at least the location and the timing information.

10. The method of claim 9, wherein the advertising system is configured to periodically provide updated transportation information and wherein the targeted advertisement changes based on changes to the timing information.

11. The method of claim 8, wherein the transportation information includes timing information indicating a time until one or more transit events and the targeted advertisement is selected based on the timing information.

12. The method of claim 8, wherein the tracking information includes timing information and the targeted advertisement is selected based on the timing information and predicted weather conditions for the timing information.

13. The method of claim 8, wherein the tracking information includes timing information and the targeted advertisement is selected based on the timing information and one or more user parameters.

14. The method of claim 13, the user parameters include a history of user transportation activities and the targeted advertisement is selected based on a detected deviation from the user transportation activities.

15. A computer-implemented system for providing targeted advertising information based on the content of provided transportation information, comprising:
a transportation information system configured to
receive a request for transportation information based on one or more user provided vehicle selection criteria, the vehicle selection criteria including at least a current location and a desired destination and
generate transportation information including location tracking information for a vehicle selected based on the vehicle selection criteria;
an advertising selection system configured to select one or more targeted advertisements based on at least the location tracking information for the selected vehicle and at least one of location information, timing information, weather information, and user information; and
an advertising system configured to transmit a transportation message including the transportation information and the targeted advertisement.

16. The system of claim 15, wherein the advertising system is configured to periodically provide updated transportation information and wherein the targeted advertisement changes based on changes to the timing information.

17. The system of claim 15, wherein the transportation information includes timing information indicating a time until one or more transit events and the targeted advertisement is selected based on the timing information and location information for the given location.

18. The system of claim 15, wherein the targeted advertisement is selected based on the timing information and predicted weather conditions for the timing information.

19. The system of claim 15, wherein the targeted advertisement is selected based on the timing information and one or more user parameters.

20. The system of claim 19, wherein the user parameters include a history of user transportation activities and the targeted advertisement is selected based on a detected deviation from the user transportation activities.
